(19) United States
(12) Patent Application Publication
(10) Pub. No.: US 2018/0040878 A1
(43) Pub. Date: Feb. 8, 2018

(54) METHOD FOR PREPARING ANODE MATERIAL FOR LITHIUM-ION BATTERIES

(71) Applicant: WUHAN KAIDI ENGINEERING TECHNOLOGY RESEARCH INSTITUTE CO., LTD., Wuhan (CN)

(72) Inventors: Huanhuan ZHOU, Wuhan (CN); Yuting CHENG, Wuhan (CN)

(21) Appl. No.: 15/787,697

(22) Filed: Oct. 18, 2017

Related U.S. Application Data
(63) Continuation-in-part of application No. PCT/CN2016/079380, filed on Apr. 15, 2016.

(30) Foreign Application Priority Data
Apr. 21, 2015 (CN) 201510190215.9

(51) Int. Cl. H01M 4/1393; H01M 4/1391

(52) U.S. Cl. CPC H01M 4/1393; H01M 4/1391; H01M 2004/027

(57) ABSTRACT

A method for preparing an anode material for lithium-ion batteries, the method including: (1) mixing a raw residue from a biomass gasifier and an aqueous solution including a surfactant to yield a mixed solution, grinding the mixed solution to disperse the raw residue, washing the mixed solution using water to remove the surfactant, leaching the mixed solution, to yield a first intermediate residue; (2) adding hydrochloric acid to the first intermediate residue, stirring to remove impurities, filtering, and washing the residue to be neutral, to yield a second intermediate residue; (3) adding polyethyleneimine and ethanol to the second intermediate residue, shaking, washing away the polyethyleneimine and the ethanol, filtering, to yield a third intermediate residue; and (4) adding nitric acid to the third intermediate residue, fully stirring, washing away the nitric acid, filtering and drying, to yield the anode material for lithium-ion batteries.

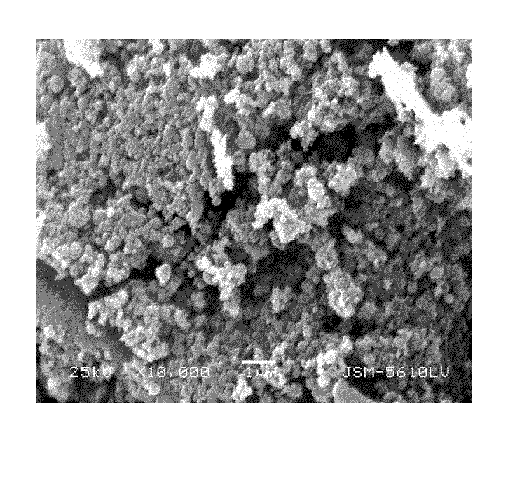

### CROSS-REFERENCE TO RELATED APPLICATIONS

This application is a continuation-in-part of International Patent Application No. PCT/CN2016/079380 with an international filing date of Apr. 15, 2016, designating the United States, now pending, and further claims foreign priority to Chinese Patent Application No. 201510190215.9 filed Apr. 21, 2015. The contents of all of the aforementioned applications, including any intervening amendments thereto, are incorporated herein by reference. Inquiries from the public to applicants or assignees concerning this document or the related applications should be directed to: Matthias Scholl P. C., Attn.: Dr. Matthias Scholl Esq., 245 First Street, 18th Floor, and Cambridge, Mass. 02142.

### BACKGROUND OF THE INVENTION

### Field of the Invention

The invention relates to a method for preparing an anode material for lithium-ion batteries using residues from biomass gasifiers.

### Description of the Related Art

Conventionally, the anode materials for lithium-ion batteries include carbon materials, tin-based materials, silicon materials and lithium titanate.

Tin-based materials exhibit poor cyclic stability, silicon materials display severe volume effect, and lithium titanate has low capacity and is relatively expensive.

Hard carbon materials are widely used as the anode materials for lithium-ion batteries. The main source of hard carbon materials are polymer compounds, which are costly and not environmentally friendly. Furthermore, the first-cycle coulombic efficiency of the hard carbon materials is relatively low.

### SUMMARY OF THE INVENTION

It is one objective of the invention to provide a method for preparing an anode material for lithium-ion batteries using a residue from a biomass gasifier of a biomass synthetic oil refinery. Through the method, the anode materials, which are economical, green and clean and have a relatively high first-cycle coulombic efficiency, are prepared.

To achieve the above objectives, in accordance with one embodiment of the invention, there is provided a method for preparing an anode material for lithium-ion batteries using a residue from a biomass gasifier, and the method comprising:
(1) mixing a raw residue from a biomass gasifier and an aqueous solution comprising a surfactant to yield a mixed solution, fully grinding the mixed solution to disperse the raw residue, washing the mixed solution using water to remove the surfactant, leaching the mixed solution and collecting a first intermediate residue;
(2) adding hydrochloric acid to the first intermediate residue obtained in (1), stirring to remove impurities, filtering, and washing the residue to be neutral, to yield a second intermediate residue;
(3) adding polyethyleneimine and ethanol to the second intermediate residue obtained in (2), shaking to disperse the second intermediate residue, washing away the polyethyleneimine and the ethanol, filtering, to yield a third intermediate residue; and
(4) adding a 55-70% (by mass) aqueous solution of nitric acid to the third intermediate residue obtained in (3), stirring at a temperature ranging between 35° C. and 45° C., washing away the nitric acid, filtering and drying, to yield the anode material for lithium-ion batteries.

In a class of this embodiment, in (1), the surfactant is sodium dodecyl benzene sulfonate, 1-hexadecylsulfonic acid sodium salt, sodium dodecyl sulfate, sodium lauryl diphenyl ether disulfonate, sodium dodecyl aliphatate, Pluronic F-127, polyethylene oxide-polypropylene oxide-polyethylene oxide (P123), sorbitan oleate (span-80), or a mixture thereof.

In a class of this embodiment, in (1), according to a mass ratio, the raw residue:the surfactant:the water=100:0.5-5: 200-1000; and a grinding time is between 15 min and 120 min.

In a class of this embodiment, in (2), a mass fraction of the hydrochloric acid is between 20% and 25%; and, according to a mass ratio, the first intermediate residue: the hydrochloric acid=1: 8-20.

In a class of this embodiment, in (3), according to a mass ratio, the second intermediate residue:polyethyleneimine:ethanol=10: 4-10:200-1000 and a shaking time is between 0.5 h and 3 h.

In a class of this embodiment, in (4), according to a mass ratio, the third intermediate residue:nitric acid=1: 5-15 and a stirring time is between 0.5 h and 3 h.

In a class of this embodiment, in (4), a grain size of the anode material for lithium-ion batteries ranges between 50 nm and 200 nm, and a specific surface area of the anode material for lithium-ion batteries is between 15 m²/g and 25 m²/g.

In a class of this embodiment, in (1), a grain size of the raw residue after being ground is between 5 μm and 20 μm.

In a class of this embodiment, in (1), the chemical compositions and mass percentage thereof of the raw residue are as follows: C: 65-70%, SiO₂: 13-18%, CaO: 3-6%, Al₂O₃: 4-7%, Fe₂O₃: 1-2%, Na₂O: 1-2%, K₂O: 1-2% and a minute amount of impurities comprising MgO and ZnO.

In a class of this embodiment, in (2), the first intermediate residue and the hydrochloric acid are stirred at a temperature of between 35° C. and 45° C. for between 0.5 h and 2 h.

Advantages of the method for preparing an anode material for lithium-ion batteries using residues according to embodiments of the present disclosure are summarized as follows:

1. The anode materials for lithium-ion batteries prepared by the invention have low ash content and small specific surface area, can reduce the boundary reaction during charge and discharge processes and have a small coulombic loss during the first charge. Due to the nanoscale sphere diameter, the anode materials for lithium-ion batteries can be closely piled to form high-density electrodes and the spherical arrangement is good for intercalation and de-intercalation of lithium ions.

2. In addition to hard carbon materials, the anode materials for lithium-ion batteries prepared by the invention also contain a small amount of SiO₂ powder. The existence of SiO₂ powder reduces the irreversible capacity during the first charge. However, the existence of SiO₂ powder reduces specific capacity. On the other hand, the micro structure of nanoscale carbon reduces the intercalation depth of lithium ions and shortens the intercalation process of lithium ions. The lithium ion can be intercalated between particle layers and in gaps between particles to improve the specific capacity of batteries, which just remedies the reduced specific capacity caused by the existence of SiO₂. For hard carbon materials, the larger irreversible capacity during the first charge is the main reason why lithium-ion batteries can't realize large-scale commercialization. The existence of SiO₂ powder of the invention remedies the shortcoming.

3. The anode materials for lithium-ion batteries prepared by the invention are hard carbon materials and are characterized by strong safety performance, good cycle performance (After 80 times of cycle, the capacity can still reach 72% of the initial capacity.) and high specific capacity (The initial specific capacity is 426 mAh/g). Since the pre-oxidation of the residues by HNO₃ the modification of the residues by the dopant N are conducted during the preparation and no other impurities are introduced, the first coulombic efficiency exceeds 80%. Compared to other hard carbon materials, the first coulombic efficiency is improved greatly. The obtained anode materials for lithium-ion batteries are characterized by high capacity, high first coulombic efficiency, good cycle performance and good rate capability and are safe and pollution-free.

4. The invention utilizes residues of biomass gasifiers of biomass synthetic oil refineries as materials to prepare anode materials for lithium-ion batteries. Since the residues have a high content of carbon and are spherical microscopically, the preparation process doesn't need complicate chemical synthesis but only need purification and modification steps. Therefore, the invention gets rid of complicate intermediate synthetic steps of traditional anode material preparing processes, saves chemical raw materials and has an advantage in price in the market.

5. The residue materials used by the invention are waste from chemical processes and are low in cost. The recycling can reduce environment pollution. The invention provides a clean renewable inexpensive new resource as raw materials for preparing hard carbon materials and an effective technical method to improve the first coulombic efficiency of hard carbon materials. The invention has a huge market advantage in terms of raw material sources, prices and product performance.

### BRIEF DESCRIPTION OF THE DRAWINGS

The invention is described hereinbelow with reference to accompanying drawings, in which the sole FIGURE is a SEM image of a residue from a biomass gasifier.

### DETAILED DESCRIPTION OF THE EMBODIMENTS

For further illustrating the invention, experiments detailing a method for preparing an anode material for lithium-ion batteries using a residue from a biomass gasifier are described hereinbelow combined with the drawings. It should be noted that the following examples are intended to describe and not to limit the invention.

Residues in the embodiment are from a biomass gasifier of a biomass synthetic oil refinery. One source of the residues is detailed as follows: the ground biomass materials contact with reaction components in the gasifier, and then are taken out of the gasifier along with the gas products. The gas products are washed by water, and then the washing liquid is filtered to yield the residue. The chemical compositions and the mass ratios thereof of the residue are as follows: C: 65-70%, SiO₂: 13-18%, CaO: 3-6%, Al₂O₃: 4-7%, Fe₂O₃: 1-2%, Na₂O: 1-2%, K₂O: 1-2% and a minute amount of impurities including MgO and ZnO. As shown in the sole FIGURE, the residue from the biomass gasifiers are spherical microscopically.

### Example 1

A method for preparing an anode material for lithium-ion batteries using a residue from a biomass gasifier comprises the following steps:

mixing a raw residue, 1-hexadecylsulfonic acid sodium salt and de-ionized water according to a mass ratio of the raw residue to the 1-hexadecylsulfonic acid sodium salt to the de-ionized water which is 100:1:500, putting the mixture of the raw residue, the 1-hexadecylsulfonic acid sodium salt and the de-ionized water to an agate mortar and grinding for 20 minutes, washing the mixture 3 times using de-ionized water to remove the 1-hexadecylsulfonic acid sodium salt, and filtering the mixture, to yield a first residue (intermediate product 1); adding hydrochloric acid with a mass fraction of 25% to the first residue (intermediate product 1) according to a mass ratio of the first residue (intermediate product 1) to the hydrochloric acid which is 1:10, stirring the mixture of the first residue (intermediate product 1) and the hydrochloric acid in a closed constant-temperature magnetic stirrer at a temperature of 40° C. for 40 minutes to remove impurities, filtering, washing the mixture 4 times until the pH value of the solution is neutral, to yield a second residue (intermediate product 2); then, putting the second residue (intermediate product 2) in an ultrasonic oscillator, adding polyethyleneimine and ethanol to the second residue (intermediate product 2) according to a mass ratio of the second residue (intermediate product 2) to polyethyleneimine to ethanol which is 10:5:500, fully shaking the mixture of the second residue (intermediate product 2), polyethyleneimine and ethanol for 1 hour, washing the mixture 3 times to remove polyethyleneimine and ethanol, filtering the mixture, to yield a third residue; finally, adding HNO₃ having a mass fraction of 65% according to a mass ratio of the third residue to nitric acid which is 1:5, stirring the mixture of the third residue and HNO₃ in a closed environment at a temperature of 40° C. for 30 minutes, fully washing the mixture 3 times, filtering and drying the mixture to obtain an anode material for lithium-ion batteries. Table 1 lists the performance parameters of the anode material for lithium-ion batteries.

### Example 2

A method for preparing an anode material for lithium-ion batteries using a residue from a biomass gasifier comprises the following steps:

mixing a raw residue, sodium dodecyl sulfate and de-ionized water according to a mass ratio of the raw residue to the 1-hexadecylsulfonic acid sodium salt to the de-ionized water which is 100:2:700, putting the mixture of the raw residue, the sodium dodecyl sulfate and the de-ionized water in an agate mortar and grinding for 40 minutes, washing the mixture 3 times using de-ionized water to remove the sodium dodecyl sulfate, and filtering the mixture, to yield a first residue (intermediate product 1); adding hydrochloric acid with a mass fraction of 20% to the first residue (intermediate product 1) according to a mass ratio of the first residue (intermediate product 1) to the hydrochloric acid which is 1:20, stirring the mixture of the first residue (intermediate product 1) and the hydrochloric acid in a closed constant-temperature magnetic stirrer at a temperature of 40° C. for one hour to remove impurities, filtering, washing the mixture 4 times until the pH value of the solution is neutral, to yield a second residue (intermediate product 2); then, putting the second residue (intermediate product 2) in an ultrasonic oscillator, adding polyethyleneimine and ethanol to the second residue (intermediate product 2) according to a mass ratio of the second residue (intermediate product 2) to polyethyleneimine to ethanol which is 10:8:1000, fully shaking the mixture of the second residue (intermediate product 2), polyethyleneimine and ethanol for 3 hours, washing the mixture 4 times to remove the polyethyleneimine and ethanol, filtering the mixture, to yield a third residue; finally, adding HNO₃ having a mass fraction of 55% according to a mass ratio of the third residue to nitric acid which is 1:8, stirring the mixture of the third residue and HNO₃ in a closed environment at a temperature of 40° C. for one hour, fully washing the mixture 4 times, filtering and drying the mixture to obtain an anode material for lithium-ion batteries. Table 1 lists the performance parameters of the anode material for lithium-ion batteries.

### Example 3

A method for preparing an anode material for lithium-ion batteries using a residue from a biomass gasifier comprises the following steps:

mixing a raw residue, sorbitan oleate (span-80) and de-ionized water according to a mass ratio of the raw residue to the sorbitan oleate (span-80) to the de-ionized water which is 100:4:1000, putting the mixture of the raw residue, the 1-hexadecylsulfonic acid sodium salt and the de-ionized water into an agate mortar and grinding for one hour, washing the mixture 3 times using de-ionized water to remove the sorbitan oleate (span-80), and filtering the mixture, to yield a first residue (intermediate product 1); adding hydrochloric acid with a mass fraction of 25% to the first residue (intermediate product 1) according to a mass ratio of the first residue (intermediate product 1) to the hydrochloric acid which is 1:15, stirring the mixture of the first residue (intermediate product 1) and the hydrochloric acid in a closed constant-temperature magnetic stirrer at a temperature of 40° C. for 1.5 hours to remove impurities, filtering, washing the mixture 4 times until the pH value of the solution is neutral, to yield a second residue (intermediate product 2); then, putting the second residue (intermediate product 2) in an ultrasonic oscillator, adding polyethyleneimine and ethanol to the second residue (intermediate product 2) according to a mass ratio of the second residue (intermediate product 2) to polyethyleneimine to ethanol which is 10:4:300, fully shaking the mixture of the second residue (intermediate product 2), polyethyleneimine and ethanol for 2 hours, washing the mixture 3 times to remove polyethyleneimine and ethanol, filtering the washed mixture, to yield a third residue; finally, adding HNO₃ having a mass fraction of 60% according to a mass ratio of the third residue to nitric acid which is 1:15, stirring the mixture of the third residue and HNO₃ in a closed environment at a temperature of 40° C. for 1.5 hours, fully washing the mixture 4 times, filtering and drying the washed mixture to obtain an anode material for lithium-ion batteries. Table 1 lists the performance parameters of the anode material for lithium-ion batteries.

TABLE 1

| | | | | | | | First |
|---|---|---|---|---|---|---|---|
| | | Grain size | | Specific | Discharge | Impurity | coulombic |
| | | d50 | Tap density | surface area | capacity | content | efficiency |
| Examples | | (μm) | (g/ml) | (m²/g) | (mAh/g) | (%) | (%) |
| 1 | | 0.41 | 0.82 | 16.1 | 308 | 0.37 | 82.5 |
| 2 | | 0.20 | 0.75 | 21.3 | 318 | 0.25 | 82.8 |
| 3 | | 0.29 | 0.80 | 18.7 | 291 | 0.28 | 81.3 |
| Prior | BTR-CMB | 11-22 | 1.1-1.4 | 0.6-2.6 | 310-340 | — | — |
| art | JFE-BAG-B2 | 10-20 | 1.1-1.45 | 0.5-2.5 | 354 | — | — |
| | CMS | 10-23 | 1.1-1.3 | 1.0-3.0 | 300-335 | — | — |

According to the performance parameters of the product of the invention and the current products, the anode materials for lithium-ion batteries prepared by the invention have the advantages that the specific capacity of the product of the invention is higher than the specific capacity of the current products, the grain size is nanoscale microspheres, the tap density is low, the content of impurities is low and the first coulombic efficiency is high. The anode materials for lithium-ion batteries prepared by the invention meet the requirements of electrode materials for lithium-ion batteries.

Unless otherwise indicated, the numerical ranges involved in the invention include the end values. While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A method for preparing an anode material for lithium-ion batteries, the method comprising:
(1) mixing a raw residue from a biomass gasifier and an aqueous solution comprising a surfactant to yield a mixed solution, grinding the mixed solution to disperse the raw residue, washing the mixed solution using water to remove the surfactant, leaching the mixed solution, to yield a first intermediate residue;
(2) adding hydrochloric acid to the first intermediate residue obtained in (1), stirring to remove impurities, filtering, and washing the residue to be neutral, to yield a second intermediate residue;
(3) adding polyethyleneimine and ethanol to the second intermediate residue obtained in (2), shaking to disperse the second intermediate residue, washing away the polyethyleneimine and the ethanol, filtering, to yield a third intermediate residue; and
(4) adding a 55-70% (by mass) aqueous solution of nitric acid to the third intermediate residue obtained in (3), stirring at a temperature of between 35° C. and 45° C., washing away the nitric acid, filtering and drying, to yield the anode material for lithium-ion batteries.

2. The method of claim 1, wherein in (1), the surfactant is sodium dodecyl benzene sulfonate, 1-hexadecylsulfonic acid sodium salt, sodium dodecyl sulfate, sodium lauryl diphenyl ether disulfonate, sodium dodecyl aliphatate, Pluronic F-127, polyethylene oxide-polypropylene oxide-polyethylene oxide, sorbitan oleate, or a mixture thereof.

3. The method of claim 1, wherein in (1), according to a mass ratio, the raw residue:the surfactant:the water=100:0.5-5: 200-1000; and a grinding time is between 15 min and 120 min.

4. The method of claim 2, wherein in (1), according to a mass ratio, the raw residue:the surfactant:the water=100:0.5-5: 200-1000; and a grinding time is between 15 min and 120 min.

5. The method of claim 1, wherein in (2), a mass fraction of the hydrochloric acid is between 20% and 25%; and, according to a mass ratio, the first intermediate residue: the hydrochloric acid=1: 8-20.

6. The method of claim 2, wherein in (2), a mass fraction of the hydrochloric acid is between 20% and 25%; and, according to a mass ratio, the first intermediate residue: the hydrochloric acid=1: 8-20.

7. The method of claim 1, wherein in (3), according to a mass ratio, the second intermediate residue:the polyethyleneimine:the ethanol=10: 4-10:200-1000 and a shaking time is between 0.5 h and 3 h.

8. The method of claim 2, wherein in (3), according to a mass ratio, the second intermediate residue:the polyethyleneimine:the ethanol=10: 4-10:200-1000 and a shaking time is between 0.5 h and 3 h.

9. The method of claim 1, wherein in (4), according to a mass ratio, the third intermediate residue: the nitric acid=1: 5-15 and a stirring time is between 0.5 h and 3 h.

10. The method of claim 2, wherein in (4), according to a mass ratio, the third intermediate residue: the nitric acid=1: 5-15 and a stirring time is between 0.5 h and 3 h.

11. The method of claim 1, wherein in (4), a grain size of the anode material for lithium-ion batteries ranges between 50 nm and 200 nm, and a specific surface area of the anode material for lithium-ion batteries is between 15 m²/g and 25 m²/g.

12. The method of claim 2, wherein in (4), a grain size of the anode material for lithium-ion batteries ranges between 50 nm and 200 nm, and a specific surface area of the anode material for lithium-ion batteries is between 15 m²/g and 25 m²/g.

13. The method of claim 1, wherein in (1), a grain size of the raw residue after being ground is between 5 μm and 20 μm.

14. The method of claim 2, wherein in (1), a grain size of the raw residue after being ground is between 5 μm and 20 μm.

15. The method of claim 1, wherein in (1), chemical compositions and mass percentage thereof of the raw residue are as follows: C: 65-70%, SiO₂: 13-18%, CaO: 3-6%, Al₂O₃: 4-7%, Fe₂O₃: 1-2%, Na₂O: 1-2%, K₂O: 1-2%, and impurities comprising MgO and ZnO.

16. The method of claim 2, wherein in (1), chemical compositions and mass percentage thereof of the raw residue are as follows: C: 65-70%, SiO₂: 13-18%, CaO: 3-6%, Al₂O₃: 4-7%, Fe₂O₃: 1-2%, Na₂O: 1-2%, K₂O: 1-2%, and impurities comprising MgO and ZnO.

17. The method of claim 1, wherein in (2), the first intermediate residue and the hydrochloric acid are stirred at a temperature of between 35° C. and 45° C. for between 0.5 h and 2 h.

18. The method of claim 2, wherein in (2), the first intermediate residue and the hydrochloric acid are stirred at a temperature of between 35° C. and 45° C. for between 0.5 h and 2 h.
